(19) United States
(12) Patent Application Publication
(10) Pub. No.: US 2015/0191080 A1
(43) Pub. Date: Jul. 9, 2015

(54) FILLER NECK FOR FILLING FUEL INTO A VEHICLE TANK OF AN AUTOMOBILE

(71) Applicant: ILLINOIS TOOL WORKS INC., Glenview, IL (US)

(72) Inventors: Christian Beck, Rottingen (DE); Matthias Kapaun, Gaukonigshofen (DE)

(21) Appl. No.: 14/413,037

(22) PCT Filed: Jul. 11, 2013
(86) PCT No.: PCT/US2013/050153

§ 371 Date: Jan. 6, 2015

(30) Foreign Application Priority Data
Jul. 13, 2012 (DE) 10 2012 013 824.5

(51) Int. Cl. B60K 15/04; B60K 15/05

(52) U.S. Cl. CPC B60K 15/04; B60K 15/05; B60K 2015/0461; B60K 2015/0483; B60K 2015/0515

(57) ABSTRACT

The invention relates to a filler neck for filling fuel into a vehicle tank of an automobile by means of a fuel nozzle, comprising an elongate section for the insertion of the fuel nozzle, wherein in the elongate section in the insertion direction of the fuel nozzle two pivotally mounted flaps are arranged behind one another, which are biased into a basic position closing the elongate section and can be pushed from this basic position into an opening position opening the elongate section by the fuel nozzle, wherein the flaps are pivotally mounted such that they pivot from their basic position into their opening position in different rotational directions, preferably in essentially opposite rotational directions.

The invention relates to a filler neck for filling fuel into a vehicle tank of an automobile by means of a fuel nozzle, comprising an elongate section for the insertion of the fuel nozzle. Filler necks for filling fuel into a vehicle tank are known for example from EP 1 551 154 B1. Said document describes in particular a so-called capless fuel filling system.

It is the object of the invention to provide a filler neck of the type specified in the introduction which, while having a small installation space requirement, is also suitable for capless fuel filling systems, and which can be used in a flexible manner with fuel filling systems of different dimensions.

The invention achieves said object by means of the subject matter of claim 1. Advantageous refinements can be found in the dependent claims, in the description and in the figures.

The invention achieves the object by means of a filler neck for filling fuel into a vehicle tank of an automobile by means of a fuel nozzle, comprising an elongate section for the insertion of the fuel nozzle, wherein in the elongate section in the insertion direction of the fuel nozzle two pivotally mounted flaps are arranged behind one another, which are biased into a basic position closing the elongate section and can be pushed from this basic position into an opening position opening the elongate section by the fuel nozzle, wherein the flaps are pivotally mounted such that they pivot from their basic position into their opening position in different rotational directions, preferably in essentially opposite rotational directions.

In a manner known per se, the filler neck comprises an elongate section for the insertion of a fuel nozzle. The elongate section may in particular be tubular. According to the invention, two flaps are situated in the elongate section. Said flaps are biased into a basic position, for example by means of suitable springs. In their basic position, the flaps substantially completely close off the elongate section. The passage of a small amount of gases and/or liquids may be permitted. The fuel nozzle is pushed into said elongate section through the insertion opening of the elongate section in an insertion direction which corresponds to an axial direction of the elongate section. The elongate section may have multiple subsections which may be arranged at an angle with respect to one another, wherein one or more curved sections are then provided between said subsections. Each of the subsections connected by the one or more curved sections may then define an axial direction specific to said subsection.

In the filler neck according to the invention, the flaps are pushed open from the basic position into their open position by the fuel nozzle as the latter is inserted. For this purpose, the flaps are in each case mounted so as to be pivotable about a pivot axis which runs generally perpendicular to the axial direction of the elongate section or to the insertion direction of the fuel nozzle. According to the invention, the flaps open in different directions of rotation, preferably in substantially opposite directions of rotation. In the case of opposite directions of rotation, slight deviations from the opposite direction of rotation are possible if this does not hinder the opening of the flaps. The flaps are thus mounted so as to be pivotable in opposite directions, such that they correspondingly open in opposite directions. Here, it is basically possible to freely choose which of the flaps opens in one direction, for example upward, and which of the flaps opens in the other direction, for example downward. As a result of the configuration with the flaps opening in opposite directions, the flaps can be arranged with a small spacing in the axial direction of the elongate section.

Overall, therefore, the filler neck has a smaller installation space requirement. The filler neck according to the invention can thus also be used in particular for fuel filling systems with short fuel nozzles, such as are provided for example in the USA. Then, owing to the small spacing, said short fuel nozzles can open both flaps without problems.

The flaps may in particular be pivotably mounted on mutually opposite wall sections of the elongate section and so as to be offset with respect one another in an axial direction of the elongate section. The pivot bearings for the flaps are thus arranged on opposite sides of the elongate section and one behind the other in the axial direction of the elongate section or in the insertion direction of the fuel nozzle.

In their basic position, the flaps may be arranged at an angle with respect to one another. In particular, the angle may lie in a range from 20° to 70°, preferably in a range from 30° to 60°. The flaps are generally of an areal form. In this embodiment, planes spanned by the flaps, for example the planes spanned in each case by their (planar) front or rear sides, or for example the planes spanned in each case by the (shortest) connection between the pivot axis and the opposite free end of the flaps, are at an angle with respect to one another. This allows the pivot axes, and thus the flaps, to be arranged even closer to one another. In particular, the pivot axis of the posterior flap in the insertion direction of the fuel nozzle can be arranged closer to the anterior flap in the axial direction.

The anterior flap in the insertion direction of the fuel nozzle into the elongate section may, in its basic position, be arranged substantially perpendicular to the axial direction of the elongate section. The posterior flap in the insertion direction of the fuel nozzle into the elongate section may, in its basic position, be arranged obliquely with respect to the axial direction of the elongate section. In particular, said posterior flap may, in its basic position, be arranged at an angle in a range from 20° to 70°, preferably in a range from 30° to 60°, with respect to the axial direction of the elongate section or the insertion direction of the fuel nozzle. The anterior flap is the flap that the fuel nozzle abuts against first during the insertion thereof into the elongate section. The posterior flap is correspondingly the flap that the fuel nozzle abuts against second during the insertion thereof into the elongate section. As explained above, the specified angles are in particular in relation to planes spanned in each case by the flaps, for example by the planes spanned by the (planar) front or rear sides of said flaps or for example the planes spanned by the (shortest) connection between the pivot axis and the opposite free end of the flaps. As already mentioned, the insertion direction of the fuel nozzle runs in particular along the axial direction of the elongate section. In the case of the flap being arranged at an angle not equal to 90° with respect to the axial direction of the elongate section, the fuel nozzle, during the insertion thereof, thus abuts against an obliquely oriented flap. This improves the insertion behavior of the fuel nozzle. Furthermore, it allows the pivot axes and thus the flaps to be arranged closer to one another. Furthermore, a space which is situated between the flaps and in which liquid can undesirably accumulate can be minimized.

The pivot axis of the posterior flap in the insertion direction of the fuel nozzle into the elongate section may be situated in front of a stop in the insertion direction of the fuel nozzle, said stop being provided for the end of the posterior flap situated opposite the pivot axis when said posterior flap is in its basic position. The flaps, in their basic position, are in each case pressed with their free end situated opposite the pivot axis against a stop, for example a stop surface for example of the elongate section, by the biasing action. The fuel nozzle thus abuts against an oblique posterior flap, wherein, as the flap opens, the fuel nozzle firstly passes the pivot axis of the flap, and subsequently passes the stop.

The invention also relates to a fuel filling system having a filler neck according to the invention, wherein the fuel filling system is a capless fuel filling system. The invention also relates to a fuel filling system having a filler neck according to the invention, wherein the fuel filling system has a misfuel inhibitor. The latter subjects of the invention may self-evidently also be combined with one another. The invention may in particular be used for deflectors with or without a misfuel inhibitor (MFI) or for capless systems with or without a misfuel inhibitor (MFI).

An exemplary embodiment of the invention will be explained in more detail below on the basis of schematic figures, in which:

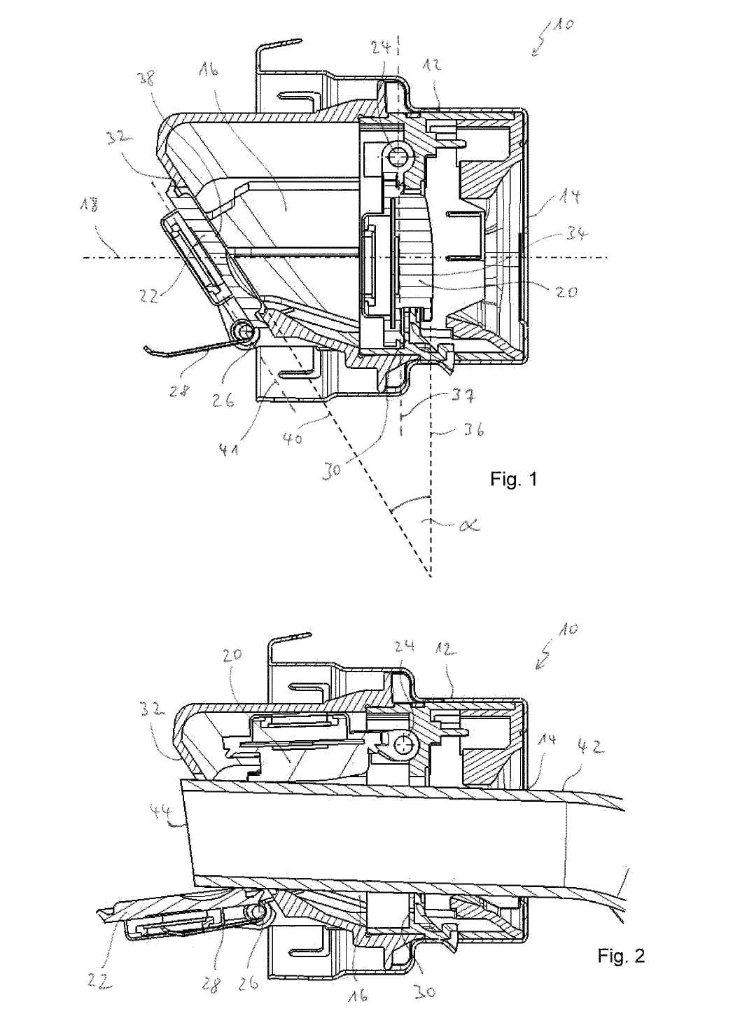

FIG. 1 shows a filler neck according to the invention in a sectional view in a first operating state, and

FIG. 2 shows the filler neck from FIG. 1 in a sectional view in a second operating state.

Unless stated otherwise, in the figures, the same reference numerals are used to denote identical items. FIG. 1 shows, in a sectional view, a filler neck 10 according to the invention with a housing 12, composed for example of a plastic. The housing 12 has a for example circular insertion opening 14 which opens into an elongate section 16, in particular a tubular section 16. The reference numeral 18 indicates the axial direction of the elongate section 16. In the example shown, the elongate section 16 may for example be circular in cross section. In the elongate section 16, a first flap 20 and a second flap 22 are arranged one behind the other. The first flap 20 is pivotably mounted on one side, the top side in FIG. 1, of the elongate section 16 by means of a pivot bearing 24. The pivot axis runs perpendicular to the axial direction 18 of the elongate section 16, into the plane of the drawing in FIG. 1. The second flap 22 is pivotably mounted likewise on one side, the bottom side in FIG. 1, of the elongate section 16 by means of a pivot bearing 26. The pivot axis of the pivot bearing 26 in turn runs perpendicular to the axial direction 18 of the elongate section 16, into the plane of the drawing in FIG. 1. In FIG. 1, the flaps 20, 22 are situated in each case in the closed basic position thereof, in which they close off the passage through the elongate section 16. The flaps 20, 22 are biased into said basic position, in particular by in each case one spring, one of which is indicated by the reference numeral 28. In said closed basic position, the first flap 20 is pressed with its free end situated opposite the pivot bearing 24 against a stop surface 30 of the elongate section 16. Correspondingly, the second flap 22 is pressed with its free end situated opposite the pivot bearing 26 against a stop surface 32 of the elongate section 16.

It can be seen in FIG. 1 that the first flap 20, in its closed basic position, is arranged substantially perpendicular to the axial direction 18 of the elongate section 16, which is simultaneously the insertion direction of a fuel nozzle into the filler neck 10. In particular, a plane spanned for example by the (planar) front side 34 of the first flap 20 runs perpendicular to the axial direction 18, as indicated by the dashed line 36 in FIG. 1. It can likewise be seen in FIG. 1 that the second flap 22, in its closed basic position, is arranged obliquely with respect to the axial direction 18 of the elongate section 16. In particular, a plane spanned by the (planar) front side 38 of the second flap 22 runs at an angle α not equal to 90° with respect to the axial direction 18, as indicated by the dashed line 40 in FIG. 1. It can be seen that the same angle is formed between for example planes spanned by each of the (planar) rear sides of the flaps or between the planes spanned in each case by the (shortest) connection between the pivot axis and the opposite free end of the flaps (20, 22). For clarity in FIG. 1, the latter planes are indicated by dashed lines at the reference numerals 37 and 41. Here, the pivot bearing 26 of the second flap 22 is arranged in front of the stop surface 32 as viewed in the insertion direction of the fuel nozzle, that is to say from right to left in FIG. 1. As can also be seen in FIG. 1, the first flap 20 and the second flap 22 are situated at an angle with respect to one another, said angle being denoted in FIG. 1 by the reference sign a. In the example shown, said angle α is approximately 32°.

FIG. 2 shows the filler neck 10 with a fuel nozzle 42 inserted through the insertion opening 14 into the elongate section 16. It can be seen here that, during the insertion into the elongate section 16, the fuel nozzle 42 has, by way of its front end 44, pushed firstly the anterior flap 20 and subsequently the posterior flap 22 out of the closed basic position thereof into an open position. Here, the flaps 20, 22 have been pivoted open in opposite rotational directions about their respective pivot bearings 24, 26. As can be seen in FIG. 2, the flaps 20, 22 thus open in particular in opposite directions. In this state, fuel can be filled into a vehicle tank of an automobile equipped with the filler neck 10 according to the invention. The fuel nozzle 42 can subsequently be pulled out of the elongate section 16 of the filler neck 10 again, wherein the flaps 20, 22, driven by the respective springs, move back into their closed basic position shown in FIG. 1.

Owing to the fact that the flaps 20, 22 open in opposite directions and owing to the arrangement of the flaps at an angle with respect to one another, as explained above, the installation space of the filler neck according to the invention is reduced in relation to the prior art. Here, use may also be made of fuel nozzles of a short length, such as are provided for example in the USA. Finally, the space between the flaps 20, 22 can be kept particularly small, such that undesired accumulations of liquid can be minimized.

1. Filler neck for filling fuel into a vehicle tank of an automobile with a fuel nozzle, comprising an elongate section for inserting the fuel nozzle, wherein in the elongate section in the insertion direction of the fuel nozzle two pivotally mounted flaps are provided behind one another, which are biased into a basic position closing the elongate section and can be pushed from this basic position into an opening position opening the elongate section by the fuel nozzle, wherein the flaps are pivotally mounted such that they pivot from their basic position into their opening position in different rotational directions, preferably in essentially opposite rotational directions.

2. Filler neck according to claim 1, wherein the flaps are pivotally mounted on wall sections of the elongate section which are opposite one another and are pivotally mounted offset to one another in the axial direction of the elongate section.

3. Filler neck according to claim 1, wherein the flaps are provided in an angle (α) towards one another in their basic position.

4. Filler neck according to claim 3, wherein the angle (α) lies in a range of 20° to 70°, preferably in a range of 30° to 60°.

5. Filler neck according to claim 1, wherein the flap which is anterior in the insertion direction of the fuel nozzle into the elongate section is provided essentially perpendicular to the axial direction of the elongate section in its basic position.

6. Filler neck according to claim 1, wherein the flap which is posterior in the insertion direction of the fuel nozzle into the elongate section is provided inclined to the axial direction of the elongate section in its basic position.

7. Filler neck according to claim 1, wherein the flap which is posterior in the insertion direction of the fuel nozzle into the elongate section is provided at an angle in a range of 20° to 70°, preferably in a range of 30° to 60°, to the axial direction of the elongate section in its basic position.

8. Filler neck according to claim 1, wherein the pivoting axis of the flap which is posterior in the insertion direction of the fuel nozzle into the elongate section lies before a stop, in the insertion direction of the fuel nozzle, wherein the stop is provided for the end of the posterior flap lying opposite to the pivot axis in its basic position.

9. Fuel filling system, characterized by a filler neck according to claim 1, wherein the fuel filling system is a capless fuel filling system.

10. Fuel filling system, characterized by a filler neck according to claim 1, wherein the fuel filling system comprises a misfuel inhibitor (MFI).
